(19) United States
(12) Patent Application Publication
(10) Pub. No.: US 2005/0062841 A1
(43) Pub. Date: Mar. 24, 2005

(54) System and method for multi-media record, distribution and playback using wireless communication

(76) Inventor: Carlos A. Rivera-Cintron, Lake Worth, FL (US)

Correspondence Address: PABLO MELES, ESQ.;AKERMAN, SENTERFITT, 222 Lakeview Avenue, 4th Floor, P. O. Box 3188, West Palm Beach, FL, 33402-3188, US

(21) Appl. No.: 10/666,612

(22) Filed: Sep. 18, 2003

(51) Int. Cl. H04N 7/14

(52) U.S. Cl. 348/14.02

(57) ABSTRACT

A system (10) of recording and distributing a multimedia presentation of an event experienced by a participant (22) includes at least a camera (18 or 20) for recording the event in a video presentation, a haptic information generator (14) for generating signals simulating the motion experienced at the event, and a processor (12) for combining the haptic information with the video presentation forming the multimedia presentation. The system also includes a heart monitor (23) for recording the heart beat of the participant simultaneously with the recording of the event and a transmitter (25) for transmitting the presentation to a portable communication device (38). A monitor (24) can display at least a portion of the presentation before the participant or other individual decides to purchase the presentation. Software and hardware in the device (38 or 40) is used to playback the synchronized audio, video and haptic elements of the multimedia presentation.

### CROSS-REFERENCE TO RELATED APPLICATIONS

Not applicable

### FIELD OF THE INVENTION

This invention relates generally to multimedia systems, and more particularly to recording, distributing, and playing back a multimedia presentation.

### BACKGROUND OF THE INVENTION

Several amusement park rides take still pictures of the ride participants and offer such pictures to the participants for a price as they exit the ride. Other amusement venues take video images and illustrate a first frame of the video on display monitors as the ride participants exit. Of course, individuals can use personal video cameras on some rides, but generally, a ride participant shooting their own video is highly impractical. On any ride that has a bit of motion, the rider takes the chance of losing their camera, endangering themselves and others, and further causing themselves to miss out on the “thrill” of the ride for a video presentation that will likely be poor in quality due to poor lighting and excess noise and motion. Furthermore, even if a ride participant were to affix a video camera somehow using a tripod, a helmet camera or otherwise, such a video during playback would still lack the motion feeling and “thrill” experienced on the ride. Thus, a need exists for a record, distribution and play back system of an event such as an amusement ride that provides motion or an additional sensory information not currently available in existing playback devices.

### SUMMARY OF THE INVENTION

A method and system to capture a multimedia presentation such as a movie of an event further includes audio, video, and haptic elements. The event can be for example a ride in an amusement park rollercoaster. The haptic elements can help simulate, for example, the shakes and bumps of the ride and/or a rider's heart beat. The multimedia presentation can be optimized to be playback in a cellular phone with a vibrating device (to simulate the ride's shakes and bumps) and a light emitting diode (LED) to simulate an event participant's or rider's heart rate. Also, the multimedia presentation can be downloaded into a rider's phone as he/she is exiting the rollercoaster ride using short range wireless network. Of course, the scenarios where such a system and method can be used is not limited to an amusement ride, but can be used in any number of events such as a parachute jump, a concert, a sporting event, and a travel adventure to name a few.

In a first embodiment in accordance with the present invention, a method of capturing audio, video, and additional sensory information during an event can include the steps of recording a multimedia presentation of the event having video and audio, and combining haptic information simulating the motion experienced during the event with the multimedia presentation recorded. The step of recording can further include the step of recording an event participant's heartbeat simultaneously with the recording of the video and audio.

In a second embodiment, a system of recording and distributing a multimedia presentation of an event experienced by a participant can include at least one digital camera for recording the event experienced by the participant in a video presentation, a haptic information generator for generating signals simulating the motion experienced at the event, and a processor for combining the haptic information with the video presentation forming the multimedia presentation. The system can further include a heart monitor for recording the heart beat of the participant simultaneously with the recording of the event and a wireless transmitter for transmitting the multimedia presentation to a portable communication device. A monitor can be used for viewing at least a portion of the multimedia presentation.

In a third embodiment, a device for ordering, receiving, and playing a multimedia presentation can include a transceiver, a display, a vibration device, and a processor coupled to the transceiver and the display. The device can further include a light source coupled to the processor and wherein the multimedia presentation contains a heart rate file used by the processor to selectively activate the light source. The device can also include a transducer for providing an audio output of the multimedia presentation. The processor can be programmed to selectively receive the multimedia presentation over the air, wherein the multimedia presentation contains haptic information synchronized with the multimedia presentation and to selectively activate the vibration device in accordance with the haptic information. The processor can be further programmed to perform a credit card transaction with a vendor of the multimedia presentation. The device can be any number of device that can receive a video presentation, including, but not limited to, a cellular phone, a computing device coupled to a wireless local area network, a data transceiver, a smartphone, and a video camera having a wireless link.

In yet another embodiment, a method of distributing a multimedia presentation of an event to an event participant can include the steps of recording a multimedia presentation, combining haptic information simulating the motion experienced during the event with the multimedia presentation recorded, presenting at least a portion of the multimedia presentation along with an identifier to the event participant, and offering the multimedia presentation to the event participant for purchase. The method can further include the step of wirelessly downloading the multimedia presentation to a portable communication device upon completing a purchase transaction.

In a final embodiment, a method of distributing a multimedia presentation of an event to an event participant can include the steps of recording a multimedia presentation, presenting at least a portion of the multimedia presentation along with an identifier to the event participant, and offering the multimedia presentation to the event participant for purchase. Upon completing a purchase transaction, the method can further include the step of wirelessly downloading the multimedia presentation to a portable communication device.

### BRIEF DESCRIPTION OF THE DRAWINGS

FIG. 1 is an illustration of a system of recording and distributing as well as receiving a multimedia presentation of an event in accordance with the present invention.

FIG. 2 is a block diagram of a device such as a cellular phone used in accordance with the present invention.

FIG. 3 is a flow chart illustrating a method of capturing and distributing a multimedia presentation in accordance with the present invention.

FIG. 4 is a flow chart illustrating a method of receiving and playing a multimedia presentation in accordance with the present invention.

### DETAILED DESCRIPTION OF THE DRAWINGS

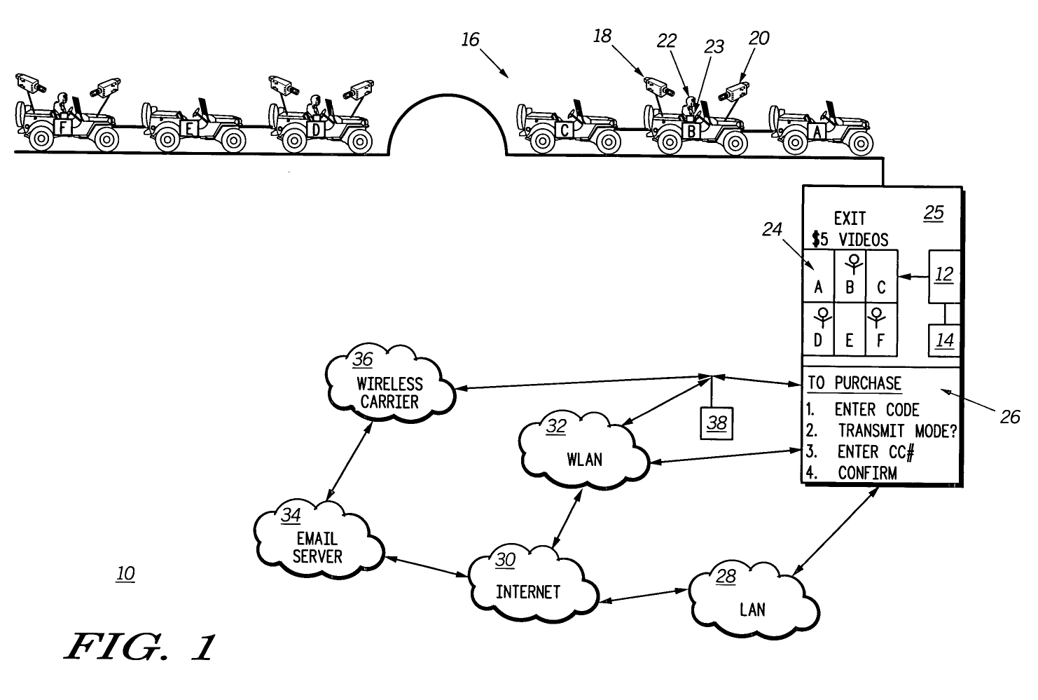

Referring to FIG. 1, there is shown a system 10 of recording and distributing a multimedia presentation of an event experienced by a participant 22. The event can be any variety of event such as an amusement ride, a parachute jump, a concert, a sporting event, or a travel adventure. A rollercoaster ride using a roller coaster 16 is shown as a mere example. The system 10 can include at least one digital camera (18 and 20) for recording the event experienced by the participant 22 in a video presentation, an optional haptic information generator 14 for generating signals simulating the motion experienced at the event, and a processor 12 for optionally combining the haptic information with the video presentation forming the multimedia presentation. If the event or ride is a “fixed” ride that does not vary significantly from one rider to the next, then the haptic information can be a predetermined signal that simulates or substantially simulates the motion experience at the event or ride. The cameras used can be taken from various perspectives and is not necessarily limited to any particular view. For example, the video can be taken from the participant's viewing perspective or the video can be taken of the participant's face or any combination thereof. The system can further include a heart monitor 23 for recording the heart beat of the participant simultaneously with the recording of the event and a wireless transmitter or transmitter station 25 for transmitting the multimedia presentation to a portable communication device 38. A monitor 24 or multiple monitors can be used for viewing at least a portion of the multimedia presentation. The transmitter station 25 can include a distribution computer (which the processor 12 can be a part of) that uploads the multimedia presentation and synchronizes the multimedia presentation with the haptic information. Alternatively, the distribution computer can upload the multimedia presentation and a heart rate file generated from the heart monitor 23 and synchronizes the multimedia presentation with the haptic information. Also note that the heart beat information from the heart rate file can optionally form a part of the haptic information.

A participant or anyone authorized can optionally use a graphic interface 26 to purchase the multimedia presentation. The interface can be centrally located near or at the facilities having the distribution computer and monitors or can optionally be part of the portable communication device 38. In any event, the interface 26 can enable the participant to enter the code corresponding to their multimedia presentation, the preferred mode of delivery, form of payment (preferably credit card) for an order, and confirmation of such order or orders. The means of distribution can be in any number of ways including a direct electronic or wireless distribution to the portable communication device 38, wired or wireless transmission via LAN 28, internet 30, email server 34, and wireless carrier 36 to the device 38. Other options include wireless transmission via a wireless local area network 32 transmitting to the portable communication device 38 using the 802.11 or Bluetooth protocols for example.

More specifically in a given embodiment, the capture device hardware described above can be a small digital camera focused at the ride participant (and mounted on roller coaster) as well as a heart rate sensor (mounted in a security harness for example). The device capture hardware can also include a processor or microcontroller and memory (not shown) to store digital information about the heart rate and the camera output (such as MPEG data). The camera and heart monitor can both be connected to a dedicated microcontroller which saves this information in memory. The device capture hardware can be programmed so that when the rider enters the ride and the ride starts, the device starts capturing the rider's heart rate, audio, and image such as the rider's face or the rider's view. The distribution hardware is preferably on the ride's facilities, but not necessarily on the ride or rollercoaster itself. The distribution hardware can include a central computer (25) and at least one monitor 24 to display at least one frame of the movie or video captured.

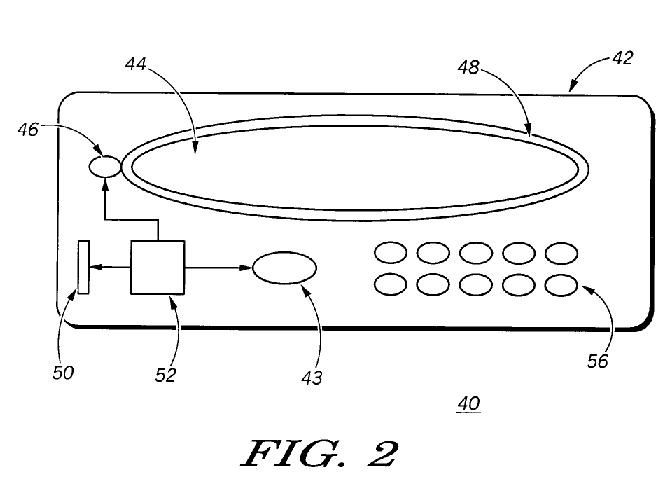

Referring to FIGS. 1 and 2, the playback hardware can be any portable communication device (38) capable of displaying the multimedia presentation and also suitable for ordering and receiving the multimedia presentation having haptic information synchronized with the multimedia presentation. The device 38 can be cellular phone, a computing device coupled to a wireless local area network, a data transceiver, a smartphone, and a video camera having a wireless link to name a few. Optionally, the device 38 should be able to perform a credit card transaction with a vendor of the multimedia presentation. Preferably, as shown in FIG. 2, the playback hardware can be a cellular phone 40 having a color display 44 and enabled with light sources and a vibration device 50. The cellular phone 40 preferably includes a transceiver, the vibration device 50, a transducer or speaker 43, and a processor 52 within a housing 42. The processor can be coupled to the transceiver and the display and further be programmed to selectively receive the multimedia presentation over the air and selectively activate the vibration device in accordance with the haptic information. The light source or light sources can be a LED 46 and or lightpipe 48. The LED 46 can also be coupled to the processor to enable the multimedia presentation to use the processor to activate the light source or LED 46 in accordance with the heart rate file or haptics contained within the presentation. The transducer 43 can also be coupled to the processor 52 and can provide an audio output for the multimedia presentation. As will be further discussed below, the processor can also be programmed to determine when the device is capable of using a particular media source such as the audio source, the light source, and the vibration device as a motion source and accordingly enables the device for presenting the multimedia presentation with the respective sources.

Each of the systems and devices described above will ideally use suitable software. For example, the capture software in the video camera can include standard audio/video embedded digital camera software (such as MPEG compression, etc). The heart rate monitor or measuring device can include software to store heart rate measurements and audio/video into memory. The distribution software can include the “Haptic info” file describing the rollercoaster mechanical bumps and shakes, the software to receive information from capture device as well as a database to aid in tracking a number of participants. Furthermore, the system will preferably include software to merge information from the capture device with a “haptic definition file” and create the final ride movie, software to assign unique identifiers to the movie's 1^{st} frame and display it in the monitor, and software to send the final movie to a playback device. The playback software preferably includes software to download the final movie from the distribution device and software to playback the final movie using for example the cellular phone's display, speaker, LED, and vibrator.

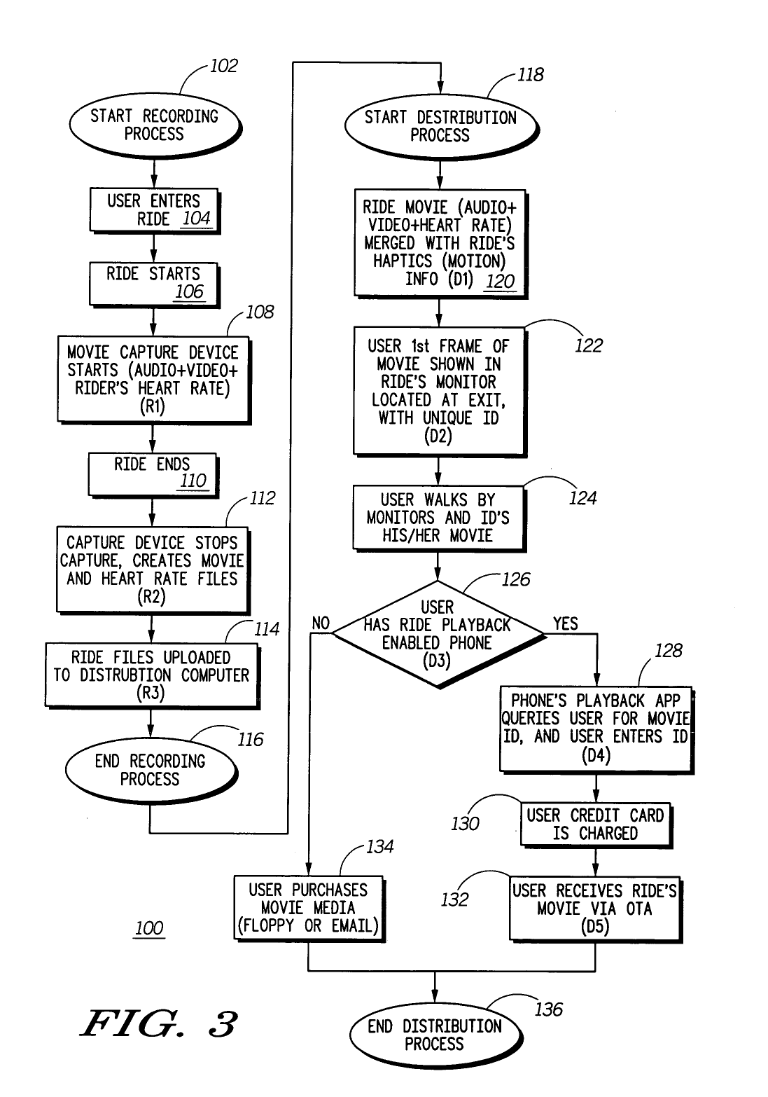

Referring to FIG. 3, a flow chart illustrates a method 100 of capturing audio, video, and additional sensory information during an event. The method 100 can simply include the steps of recording a multimedia presentation of the event having video and audio and combining haptic information simulating the motion experienced during the event with the multimedia presentation recorded. As shown, the method 100 can begin at step 102 by starting the recording process where the participant or rider enters the ride at step 104 and the ride starts at step 106. At step 108, the capture device captures the event in a multimedia presentation including audio, video, and optionally heart rate information before the ride ends at step 110. The participant's heartbeat is preferably simultaneously recorded with the video and audio. The capture device stops at step 112 and uploads the information captured to a distribution computer at step 114 where the recording process ends at block 116 and the distribution process begins at block 118. At step 120 the captured movie (video, audio, & heart rate information) can be optionally merged or combined (and preferably synchronized) with haptic information (motion). A first or any frame or frames of the movie can be shown at a monitor at step 122 at an exit station where the participant can hopefully see a portion of the presentation at step 124 as they pass by. Assuming the participant wants to purchase the multimedia presentation, a decision block 126 determines whether the purchaser has a suitably enabled receiving and playback device. If not, the participant has the option to purchase the multimedia presentation on a recordable media or via email at step 134 before ending the distribution process at step 136. If the participant has a suitable receiving and playback device, the playback application in the playback device will query the device user or participant for a movie identifier (A, B, C, D, E, F, for example) and the user can enter the identifier at step 128. The software in the device can also enable the purchase of the multimedia presentation using a user's credit card at step 130. At step 132, the user of the device can then receive the multimedia presentation over the air or any number of ways as prescribed.

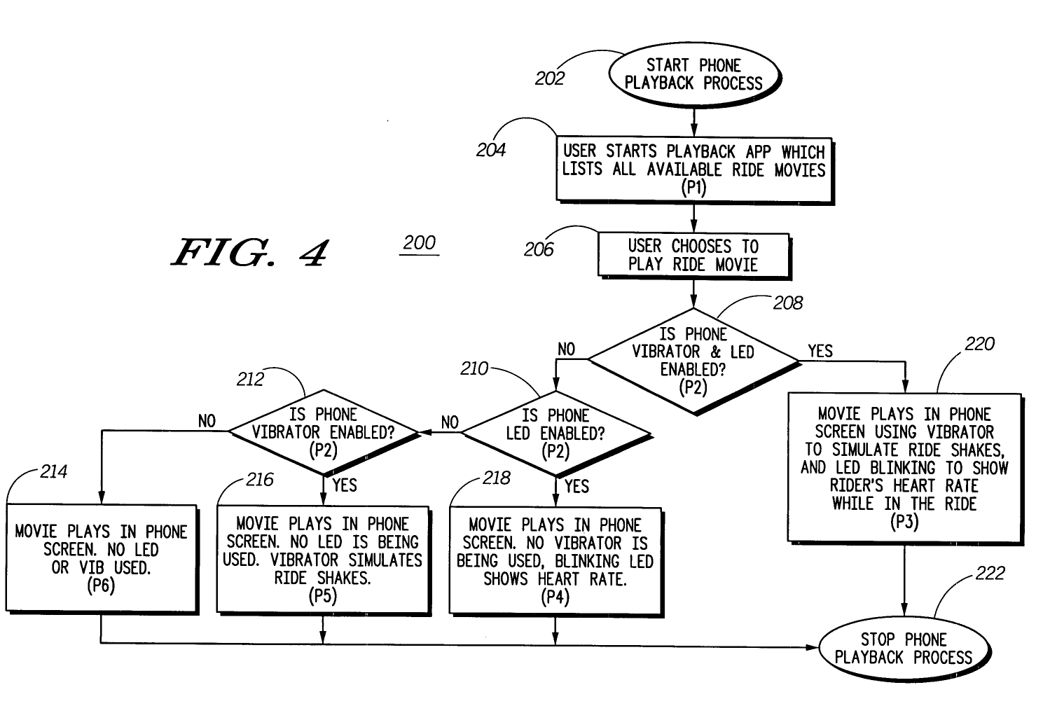

Referring to FIG. 4, a flow chart illustrates the playback method 200 of an overall method of distributing a multimedia presentation of an event to an event participant or any desired purchaser. The method 200 can include the steps of recording a multimedia presentation of the event having video and audio, combining haptic information simulating the motion experienced during the event with the multimedia presentation recorded, presenting at least a portion of the multimedia presentation along with an identifier to the event participant, and offering the multimedia presentation to the event participant for purchase. The overall method can further include the steps of wirelessly downloading the multimedia presentation to a portable communication device upon completing a purchase transaction.

Referring once again to FIG. 4, once the playback process begins at block 202, the playback device user or ride participant can start an application that will list the available multimedia presentations at step 204. Once the user selects a particular presentation at step 206, a decision block 208 determines if the playback device is enabled to use various sources such as an LED or a vibrator or other device. If the playback device is enabled to use a light source such as the LED and the vibrator, then the method 200 plays the multimedia presentation at step 220 on a display such as a phone screen using the vibrator to simulate ride shakes and a blinking LED to show the participant's heart rate during the ride. If both the vibrator and LED are not enabled at decision block 208, then the method 200 determines if at least the LED is enabled at decision block 210. If the LED is enabled at decision block 210, then the the multimedia presentation is played using the blinking LED and no vibrator at step 218. If the LED is not enabled at decision block 210, then decision block 212 determines if the vibrator is enabled. If the vibrator is enabled at decision block 212, then the multimedia presentation is played using the vibrator without using the LED at step 216. If the vibrator is not enabled at decision block 212, then the multimedia presentation plays without the vibrator and without the LED at step 214.

In light of the foregoing description of the invention, it should be recognized that the present invention can be realized in hardware, software, or a combination of hardware and software. A system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the methods described herein, is suited. A typical combination of hardware and software could be a general purpose computer system with a computer program that, when being loaded and executed, controls the computer system such that it carries out the methods described herein.

Additionally, the description above is intended by way of example only and is not intended to limit the present invention in any way, except as set forth in the following claims.

1. A method of capturing audio, video, and additional sensory information during an event, comprising:
recording a multimedia presentation of the event having video and audio; and
combining haptic information simulating the motion experienced during the event with the multimedia presentation recorded.

2. The method of claim 1, wherein the step of recording further comprises the step of recording an event participant's heartbeat simultaneously with the recording of the video and audio.

3. The method of claim 1, wherein the step of combining further comprises the step of synchronizing the haptic information with the multimedia presentation recorded.

4. A system of recording and distributing a multimedia presentation of an event experienced by a participant, comprising:
at least one digital camera for recording the event experienced by the participant in a video presentation;
a haptic information generator for generating signals simulating the motion experienced at the event;
a processor for combining the haptic information with the video presentation forming the multimedia presentation; and
a wireless transmitter for transmitting the multimedia presentation to a portable communication device.

5. The system of claim 4, wherein the system further comprises a heart monitor for recording the heart beat of the participant simultaneously with the recording of the event.

6. The system of claim 4, wherein in the event is selected from the group comprising an amusement ride, a parachute jump, a concert, a sporting event, and a travel adventure.

7. The system of claim 4, wherein the event is an amusement ride and the haptic information is a predetermined signal.

8. The system of claim 4, wherein the event is recorded from the perspective selected from the group comprising the participant's face and the participant's visual field.

9. The system of claim 4, wherein the system further comprises a distribution computer that uploads the multimedia presentation and synchronizes the multimedia presentation with the haptic information.

10. The system of claim 5, wherein the system further comprises a distribution computer that uploads the multimedia presentation and a heart rate file generated from the heart monitor and synchronizes the multimedia presentation with the haptic information.

11. The system of claim 9, wherein the system further comprises a monitor for viewing at least a portion of the multimedia presentation.

12. A device for ordering, receiving, and playing a multimedia presentation, comprising:
a transceiver;
a display;
a vibration device; and
a processor coupled to the transceiver and the display, wherein the processor is programmed to:
selectively receive the multimedia presentation over the air, wherein the multimedia presentation contains haptic information synchronized with the multimedia presentation; and
selectively activate the vibration device in accordance with the haptic information.

13. The device of claim 12, wherein the device further comprises a light source coupled to the processor and wherein the multimedia presentation contains a heart rate file used by the processor to selectively activate the light source.

14. The device of claim 12, wherein the device further comprise a transducer for providing an audio output of the multimedia presentation.

15. The device of claim 12, wherein the device is selected from the group comprising a cellular phone, a computing device coupled to a wireless local area network, a data transceiver, a smartphone, and a video camera having a wireless link.

16. The device of claim 12, wherein the processor is further programmed to perform a credit card transaction with a vendor of the multimedia presentation.

17. The device of claim 12, wherein the transceiver is a wireless local area network transceiver.

18. The device of claim 13, wherein the light source is at least one light emitting diode.

19. The device of claim 13, wherein the processor is further programmed to determine when the device is capable of using an audio source, the light source, and the vibration device as a motion source and accordingly provides the multimedia presentation with the respective sources.

20. A method of distributing a multimedia presentation of an event to an event participant, comprising the steps of:
recording a multimedia presentation of the event having video and audio;
combining haptic information simulating the motion experienced during the event with the multimedia presentation recorded;
presenting at least a portion of the multimedia presentation along with an identifier to the event participant; and
offering the multimedia presentation to the event participant for purchase.

21. The method of claim 20, wherein the method further comprises the step of wirelessly downloading the multimedia presentation to a portable communication device upon completing a purchase transaction.

22. The method of claim 20, wherein the step of recording further comprises the step of recording an event participant's heartbeat simultaneously with the recording of the video and audio.

23. The method of claim 20, wherein the step of combining further comprises the step of synchronizing the haptic information with the multimedia presentation recorded.

24. The method of claim 20, wherein the step of offering comprises wirelessly transmitting an offer to a portable communication device.

25. A method of distributing a multimedia presentation of an event to an event participant, comprising the steps of:
recording a multimedia presentation of the event having video and audio;
presenting at least a portion of the multimedia presentation along with an identifier to the event participant;
offering the multimedia presentation to the event participant for purchase; and
wirelessly downloading the multimedia presentation to a portable communication device upon completing a purchase transaction.
